(19) United States
(12) Patent Application Publication
(10) Pub. No.: US 2022/0061276 A1
(43) Pub. Date: Mar. 3, 2022

(54) DEEP SEA FISH CULTURE LIFE SUPPORT SYSTEM

(71) Applicant: Zhilv Environmental Technology (Shanghai) Co., Ltd., Shanghai (CN)

(72) Inventors: Yangsheng JIN, Shanghai (CN); Xinqi Chu, Shanghai (CN); Yuchun Tang, Shanghai (CN)

(21) Appl. No.: 17/212,435

(22) Filed: Mar. 25, 2021

(30) Foreign Application Priority Data
Sep. 3, 2020 (CN) 202010918224.6

(51) Int. Cl. A01K 61/10; A01K 61/80

(52) U.S. Cl. CPC A01K 61/10; A01K 61/80

(57) ABSTRACT

Disclosed is a deep sea fish culture life support system. The deep sea fish culture life support system comprises a mother ship, a plurality of net cage groups and a master console, and the system further comprises an automatic feeding system, fixed positioning piles, flexible conveying pipes, rigid conveying pipes and feeding devices. By adopting the automatic feeding system, feed is timely supplied to deep sea fish according to the quantity, the fixed positioning piles are arranged at the two ends of the conveying pipes, the wind wave resistance and the water flow impact resistance are improved, the conveying pipes are laid underwater, the influence of large wind waves and severe sea conditions on feed conveying is avoided, and the safety of deep sea fish culture is effectively guaranteed.

### TECHNICAL FIELD

The present disclosure relates to fish culture, in particular to a deep sea fish culture technology.

### BACKGROUND

The twenty-first century is an ocean developing century, and the benefits of the ocean directly affect the political, economic, safe and civilized trends of the country and decide or affect the promise and fate of the country. The history of world economic development is from land to sea, from sea to the world and then to a strong country. Sea contains rich resources such as organisms, energy, minerals, tourism and aquatic products. The huge potential of converting ocean advantages into economic advantages is realized. In order to develop marine resources, in addition to developing marine minerals and petroleum resources, land aquaculture is turned into marine aquaculture in various countries in the world. Deep sea aquatic product resources are very rich, high-quality fish varieties are various, and the economic value is high. Existing deep sea fish culture in China has the main problems that when encountering heavy wind and heavy waves, feed for fish culture cannot be supplied and fed in time, so that the yield of cultured fish is greatly reduced, and wide aquaculture employees hope to develop a method capable of resisting the heavy wind and heavy waves and achieving deep sea fish culture under severe sea conditions. Therefore, the life guarantee of deep sea fish culture is achieved.

### SUMMARY

Aiming at the defects in the prior art, the technical problem to be solved by the present disclosure is to provide a deep sea fish culture life support system which can timely supply feed for deep sea culture fish according to the quantity under severe environments of heavy storm waves and sea conditions so as to ensure the safety of the deep sea culture fish.

To solve the technical problem, the deep sea fish culture life support system disclosed by the present disclosure comprises a mother ship, a plurality of net cage groups, a monitoring, supervision and control system, an underwater lighting device and a master console, the system further comprises an automatic feeding system, fixed positioning piles, flexible conveying pipes, rigid conveying pipes and feeding devices, the automatic feeding system is arranged on the other ship, the fixed positioning piles are arranged from the seabed to the sea surface on the outer side of the mother ship, the automatic feeding system on the mother ship communicates with the sea surface ends of the fixed positioning piles through the flexible conveying pipes, the fixed positioning piles are arranged from the seabed to the sea surface on the outer side of each net cage in the net cage groups, each net cage communicates with the sea surface ends of the fixed positioning piles through the flexible conveying pipes, the fixed positioning piles between the outer side of the mother ship and the outer side of each net cage are communicated from the sea surface to the seabed and along the seabed through the rigid conveying pipes, and the flexible conveying pipes at the sea surface ends communicate with the rigid conveying pipes at the sea surface ends.

The automatic feeding system comprises storage hoppers, a material conveying device, batchers, pressure regulators and distributors, an automatic discharging valve and a quantifying device are arranged at the lower end of each storage hopper, the material conveying device comprises a motor, idler wheels and a belt conveying belt, the belt conveying belt is arranged below the automatic discharging valves of the storage hoppers, a material opening is formed in the upper end of each batcher, water inlets are formed in the two sides, an automatic outlet control valve is arranged on the lower portion, the material openings of the batchers are formed in an outlet of the belt conveying belt, automatic control valves are arranged at the inlet ends and the outlet ends of the pressure regulators respectively, each pressure regulator is provided with a frequency modulation motor, the inlet end of each pressure regulator is arranged below the automatic control valve of the corresponding batcher, each distributor is provided with a plurality of branches corresponding to the net cages in number, each branch of each distributor is provided with the corresponding automatic control valve, the corresponding automatic control valve on each branch communicates with the corresponding flexible conveying pipe at the sea surface end on the outer side of the mother ship, and the distributors are arranged at the outlet ends of the automatic control valves of the pressure regulators.

The feeding devices are arranged in all the net cages, underwater or water surface feeding devices are adopted, and the underwater feeding devices are arranged under water with the depth of 1-40 m; and a plurality of spraying holes rotating by 360 degrees are formed in the water surface feeding devices. The feeding devices communicate with the automatic control valves of the distributors through the flexible conveying pipes and the rigid conveying pipes.

In the mother ship or platform, the distances between the outer side of the mother ship or platform and the fixed positioning piles and between the outer side of each net cage and the fixed positioning piles are 5-25 meters.

Compared with the prior art, the present disclosure has the following advantages and beneficial effects:

firstly, the mode that feed is conveyed through water surface wind power in traditional aquaculture is changed, rigid conveying pipelines are laid underwater, the materials are prepared into a solid-liquid mixed feed, the feed is conveyed through hydraulic power, the conveying distance is long, and safety and reliability are achieved;

secondly, the fixed positioning piles are arranged at the two ends of the conveying pipes, and the wind wave resistance and the water flow impact resistance are improved;

thirdly, the conveying pipes adopt a connection mode of flexible pipes and rigid pipes, so that dynamic balance and buffer adjusting effects are achieved under severe sea condition environments; and

the automatic feeding system is adopted to ensure timely and quantitative feed supply, so that the problem of feeding feed for deep sea culture fish is solved.

### BRIEF DESCRIPTION OF THE DRAWINGS

The following describes the present invention in detail with reference to the accompanying drawings and the embodiment.

FIG. 1 is a schematic diagram of a deep sea fish culture life support system in the present disclosure.

Reference signs: 1, mother ship; 2, a plurality of net cage groups; 3, automatic feeding system; 4, fixed positioning pile; 5, flexible conveying pipe; 6, rigid conveying pipe; 7, feeding device; 8, main console; 21, net cage; 31, storage hopper; 32, material conveying device; 33, batcher; 34, pressure regulator; and 35, distributor.

### DETAILED DESCRIPTION

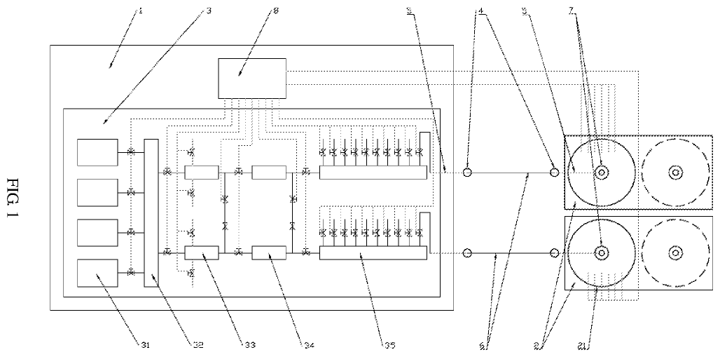

As shown in FIG. 1, a deep sea fish culture life support system disclosed by the present disclosure comprises a mother ship 1, a plurality of net cage groups 2 and a master console 8, and the system further comprises an automatic feeding system 3, fixed positioning piles 4, flexible conveying pipes 5, rigid conveying pipes 6 and feeding devices 7. The mother ship 1 in the embodiment can be a platform, the number of the net cage groups is 2-8, the number of the net cage groups 2 in the embodiment is 2, net cages 21 are arranged in each net cage group 2, the number of the net cages 21 is 10-30, and the number of the fixed positioning piles 4 corresponds to that of all the net cages 21 in the net cage groups 2. The automatic feeding system 3 is arranged on the mother ship 1, the fixed positioning piles 4 are arranged from the seabed to the sea surface on the outer side of the mother ship 1, the distances between the outer side of the mother ship 1 and the fixed positioning piles 4 are 5-25 meters in the embodiment, and the automatic feeding system 3 on the mother ship 1 communicates with the sea surface ends of the fixed positioning piles 4 through the flexible conveying pipes 5. The fixed positioning piles 4 are arranged from the sea surface to the seabed on the outer side of each net cage 21 in the net cage groups 2, the distances between the outer side of each net cage 21 in the net cage groups 2 and the fixed positioning piles 4 are 5-25 meters, and each net cage 21 communicates with the sea surface ends of the fixed positioning piles 4 through the flexible conveying pipes 5. The fixed positioning piles 4 between the outer side of the mother ship 1 and the outer side of each net cage 21 are communicated from the sea surface to the seabed and along the seabed through the rigid conveying pipes 6, and the flexible conveying pipes 5 at the sea surface ends communicate with the rigid conveying pipes 6 at the sea surface ends. The fixed positioning piles are arranged at the two ends of the conveying pipes, and the wind wave resistance and the water flow impact resistance are improved. By adopting a connection mode of the flexible conveying pipes and the rigid conveying pipes, the whole conveying pipeline system realizes dynamic balance and buffer adjusting effects under severe sea conditions. By means of a mode of laying the feeding pipes and conveying feed underwater, the risk that water surface conveying is affected by stormy waves on the sea surface is avoided, the safety of deep sea fish culture is effectively guaranteed, and the problem that deep sea fish is timely fed with the feed according to the quantity is solved.

The automatic feeding system 3 comprises storage hoppers 31, a material conveying device 32, batchers 33, pressure regulators 34 and distributors 35, an automatic discharging valve and a quantifying device are arranged at the lower end of each storage hopper 31, materials in the storage hoppers 31 are metered through a weighing and position difference device and conveyed through the material conveying device 32, and the material conveying device 32 comprises a motor, idler wheels, a belt conveying belt or a spiral conveyor. According to the embodiment, a belt is adopted for conveying, the belt conveying belt is arranged below the automatic discharging valves of the storage hoppers 31, and the belt conveying belt conveys the materials in the storage hoppers 31 to the material openings of the batchers 33. A material opening is formed in the upper end of each batcher 33, water inlets are formed in the two sides, an automatic outlet control valve is arranged on the lower portion, the material openings of the batchers are formed in an outlet of the belt conveying belt, and the batchers 33 are used for mixing a solid material and a liquid material to prepare a solid-liquid mixed feed. The feed flows into the inlet ends of the pressure regulators 34 from the automatic outlet control valves on the lower proportions of the batchers 33, automatic control valves are arranged at the inlet ends and the outlet ends of the pressure regulators 34 respectively, each pressure regulator 34 is provided with a frequency modulation motor, speed regulation and pressure regulation can be carried out according to working condition requirements so as to meet the consumption of the feed in the net cages 21, and the feed is delivered to the distributors 35 from outlets of the automatic control valves at the lower portions of the pressure regulators 34. The distributors 35 are arranged at the outlet ends of the automatic control valves of the pressure regulators 34, the arrangement of the distributors 35 is set according to the arrangement of the net cages 21, each distributor 35 is provided with branches, in the embodiment, one distributor is provided with 10-30 branches, and the number of the branches corresponds to that of the net cages 21. Each branch of each distributor 35 is provided with the corresponding automatic control valve, each automatic control valve communicates with the corresponding flexible conveying pipe 5 at the sea surface end of the corresponding fixed positioning pile 4 on the outer side of the mother ship 1.

The feeding devices 7 are arranged in all the net cages 21, underwater or water surface feeding devices are adopted, and the underwater feeding devices are arranged under water with the depth of 1-40 m; and a plurality of spraying holes rotating by 360 degrees are formed in the water surface feeding devices. The distributors 35 enable the feed to be delivered to the rigid conveying pipes 6 on the seabed through the flexible conveying pipes 5 on the sea surface from all branches, then the feed rises to the sea surface from the conveying pipes on the seabed, the feed is delivered to the feeding devices 7 of the net cages 21 through the flexible conveying pipes 5, and the feeding devices 7 spray the feed through the spraying holes by 360 degrees to feed fish.

The master console 8 is arranged on the mother ship 1, the master console 8 is provided with the monitoring, supervision and control system and an underwater lighting device, and the automatic feeding system 3 is controlled by the master console 8, in the embodiment, the automatic feeding system is provided with two batchers 33, and the mixed feed can be used as a substitute for the other one through an automatic or manual linkage valve besides flowing into the pressure regulators 34. In the embodiment, the system is provided with two pressure regulators 34, in the event of an emergency, the feed is supplied as a substitute for the net cages through an automatic or manual emergency changeover valve.

What is claimed is:

1. A deep sea fish culture life support system, comprising a mother ship, a plurality of net cage groups, a monitoring, supervision and control system, an underwater lighting device and a master console, wherein the system further comprises an automatic feeding system, fixed positioning piles, flexible conveying pipes, rigid conveying pipes and feeding devices, the automatic feeding system is arranged on the other ship, the fixed positioning piles are arranged from the seabed to the sea surface on the outer side of the mother ship, the automatic feeding system on the mother ship communicates with the sea surface ends of the fixed positioning piles through the flexible conveying pipes, the fixed positioning piles are arranged from the seabed to the sea surface on the outer side of each net cage in the net cage groups, each net cage communicates with the sea surface ends of the fixed positioning piles through the flexible conveying pipes, the fixed positioning piles between the outer side of the mother ship and the outer side of each net cage are communicated from the sea surface to the seabed and along the seabed through the rigid conveying pipes, and the flexible conveying pipes at the sea surface ends communicate with the rigid conveying pipes at the sea surface ends.

2. The deep sea fish culture life support system according to claim 1, wherein the automatic feeding system comprises storage hoppers, a material conveying device, batchers, pressure regulators and distributors, an automatic discharging valve and a quantifying device are arranged at the lower end of each storage hopper, the material conveying device comprises a motor, idler wheels and a belt conveying belt, the belt conveying belt is arranged below the automatic discharging valves of the storage hoppers, a material opening is formed in the upper end of each batcher, water inlets are formed in the two sides, an automatic outlet control valve is arranged on the lower portion of each distributor, the material openings of the batchers are formed in an outlet of the belt conveying belt, automatic control valves are arranged at the inlet ends and the outlet ends of the pressure regulators respectively, each pressure regulator is provided with a frequency modulation motor, the inlet end of each pressure regulator is arranged below the automatic control valve of the corresponding batcher, each distributor is provided with a plurality of branches corresponding to the net cages in number, each branch of each distributor is provided with the corresponding automatic control valve, the corresponding automatic control valve on each branch communicates with the corresponding flexible conveying pipe at the sea surface end on the outer side of the mother ship, and the distributors are arranged at the outlet ends of the automatic control valves of the pressure regulators.

3. The deep sea fish culture life support system according to claim 1, wherein the feeding devices are arranged in all the net cages, underwater or water surface feeding devices are adopted, and the underwater feeding devices are arranged under water with the depth of 1-40 m; and a plurality of spraying holes rotating by 360 degrees are formed in the water surface feeding devices; and the feeding devices communicate with the automatic control valves of the distributors through the flexible conveying pipes and the rigid conveying pipes.

4. The deep sea fish culture life support system according to claim 1, wherein in the mother ship or platform, the distances between the outer side of the mother ship or platform and the fixed positioning piles and between the outer side of each net cage and the fixed positioning piles are 5-25 meters.
